(19) United States
(12) Patent Application Publication
(10) Pub. No.: US 2019/0304457 A1
(43) Pub. Date: Oct. 3, 2019

(54) INTERACTION DEVICE AND PROGRAM

(71) Applicants: HONDA MOTOR CO., LTD., Tokyo (JP); Nextremer Co., Ltd., Tokyo (JP)

(72) Inventors: Mikio Nakano, Wako-shi (JP); Tomoyuki Sahata, Tokyo (JP); Taichi Iki, Tokyo (JP); Yuta Kawai, Nangoku-shi (JP)

(21) Appl. No.: 16/364,840

(22) Filed: Mar. 26, 2019

(30) Foreign Application Priority Data
Mar. 28, 2018 (JP) 2018-062055

(51) Int. Cl. G10L 15/22; G10L 15/18; G10L 15/24

(52) U.S. Cl. CPC G10L 15/22; G10L 15/24; G10L 15/1807

(57) ABSTRACT

An interaction device includes a voice collection unit that collects a speech of a speaker, a voice recognition section that recognizes voice of the speech collected by the voice collection unit, a speech content understanding section that understands a speech content on the basis of the recognized content, a response sentence generation section that generates a response sentence in accordance with the speech content, an output unit that outputs the response sentence, a detection section that detects that the speech between the speaker and the interaction device has been broken, and a connection control section that controls a connection between the speaker and a person in charge of a center on the basis of the speech content understood by the speech content understanding section and a vacant state of the person in charge of the center when the speech has been broken.

### CROSS-REFERENCE TO RELATED APPLICATION

Priority is claimed on Japanese Patent Application No. 2018-062055, filed Mar. 28, 2018, the content of which is incorporated herein by reference.

### BACKGROUND OF THE INVENTION

### Field of the Invention

The present invention relates to an interaction device and a program.

### Description of Related Art

There is a reception system that is a voice recognition chat bot installed in the reception of companies, exhibition halls and the like and understands what a visitor is talking about to present a response corresponding to the content thereof to the visitor in the form of voice or texts.

In such a reception system, a conversation between the reception system and a visitor may be broken due to, for example, misunderstanding of the content of speech by the reception system due to a voice recognition result, depending on the content of speech of a visitor. In such a case, it is possible to satisfy the request of the visitor by directly interacting with a person in charge of a center connected on-line. For this reason, there has been proposed a voice interaction system that automatically controls an intervention timing of an operator in correspondence to a user's knowledge level (for example, see Japanese Patent No. 3857047 (hereinafter, Patent Document 1)).

### SUMMARY OF THE INVENTION

However, in the technology disclosed in Patent Document 1, in a case where the reception system is disposed at many bases and is used by many visitors at the same time, there is a possibility that it is not possible to cope with a situation where every reception system in which a conversation has been broken connects to the center, due to a lack of human resources.

The present invention has been made to solve the aforementioned problems, and an object of the present invention is to provide an interaction device capable of reducing lack of human resources at a center and a program therefor.

In order to accomplish the above object, the present invention employs the following aspects.

(1) An interaction device according to an aspect of the present invention includes a voice collection unit that collects a speech of a speaker, a voice recognition section that recognizes voice of the speech collected by the voice collection unit, a speech content understanding section that understands a speech content on the basis of the recognized content, a response sentence generation section that generates a response sentence in accordance with the speech content, an output unit that outputs the response sentence, a detection section that detects that the speech between the speaker and the interaction device has been broken, and a connection control section that controls a connection between the speaker and a person in charge of a center on the basis of the speech content understood by the speech content understanding section and a vacant state of the person in charge of the center when the speech has been broken.

(2) In the aforementioned aspect (1), the connection control section may determine whether a conversation with the person in charge of the center is required in the speech on the basis of at least one of a change in prosody of the speech of the speaker collected by the voice collection unit, a change in a speed of the speech of the speaker, and a change in volume of the speech of the speaker, and perform a connection to the person in charge of the center on the basis of a determination result.

(3) In the aforementioned aspect (1) or (2), the connection control section may determine a priority in accordance with the speech content and set an order of a connection to the center on the basis of the priority.

(4) In the aforementioned aspect (3), the priority corresponding to the speech content may be changed in accordance with an environment in which the interaction device is used.

(5) In the aforementioned aspect (1) or (2), the interaction device may further include an imaging unit configured to capture an image, and the connection control section may determine a priority on the basis of the image captured by the imaging unit, and set an order of a connection to the center on the basis of the priority.

(6) A program according to an aspect of the present invention causes a computer of an interaction device to perform a voice collection step of collecting a speech of a speaker, a voice recognition step of recognizing voice of the speech collected in the voice collection step, a speech content understanding step of understanding a speech content on the basis of the recognized content, a response sentence generation step of generating a response sentence in accordance with the speech content, an output step of outputting the response sentence, a detection step of detecting that the speech between the speaker and the interaction device has been broken, and a connection control step of controlling a connection between the speaker and a person in charge of a center on the basis of the speech content understood in the speech content understanding step and a vacant state of the person in charge of the center when the speech has been broken.

According to the aforementioned aspect (1) or (6), it is possible to perform communication with a necessary speaker in accordance with the vacant state of the person in charge of the center.

According to the aforementioned aspect (2), only a speaker (a sincere person) required to communicate with an operator can be connected to the operator on the basis of a voice signal.

According to the aforementioned aspect (3), speakers with higher priority conversations can be sequentially connected to an operator.

According to the aforementioned aspect (4), speakers with higher priority conversations according to installation places can be sequentially connected to an operator.

According to the aforementioned aspect (5), only a speaker (a sincere person) required to communicate with an operator can be connected to the operator on the basis of an image.

### BRIEF DESCRIPTION OF THE DRAWINGS

FIG. 1 is a diagram illustrating an example of a configuration of an interaction device according to a first embodiment.

FIG. 2 is a diagram illustrating an example of information stored in a contact storage section according to a first embodiment.

FIG. 3 is a diagram illustrating an example of interaction between an interaction device according to a first embodiment and a speaker (a visitor).

FIG. 4 is a flowchart illustrating an example of a procedure performed by an interaction device according to a first embodiment.

FIG. 5 is a flowchart illustrating an example of a procedure performed by an interaction device in a modification example of a first embodiment.

FIG. 6 is a diagram illustrating an example of a configuration of an interaction device according to a second embodiment.

FIG. 7 is a diagram illustrating an example of a configuration of an interaction device according to a third embodiment.

### DETAILED DESCRIPTION OF THE INVENTION

Hereinafter, embodiments of the present invention will be described with reference to the drawings.

### First Embodiment

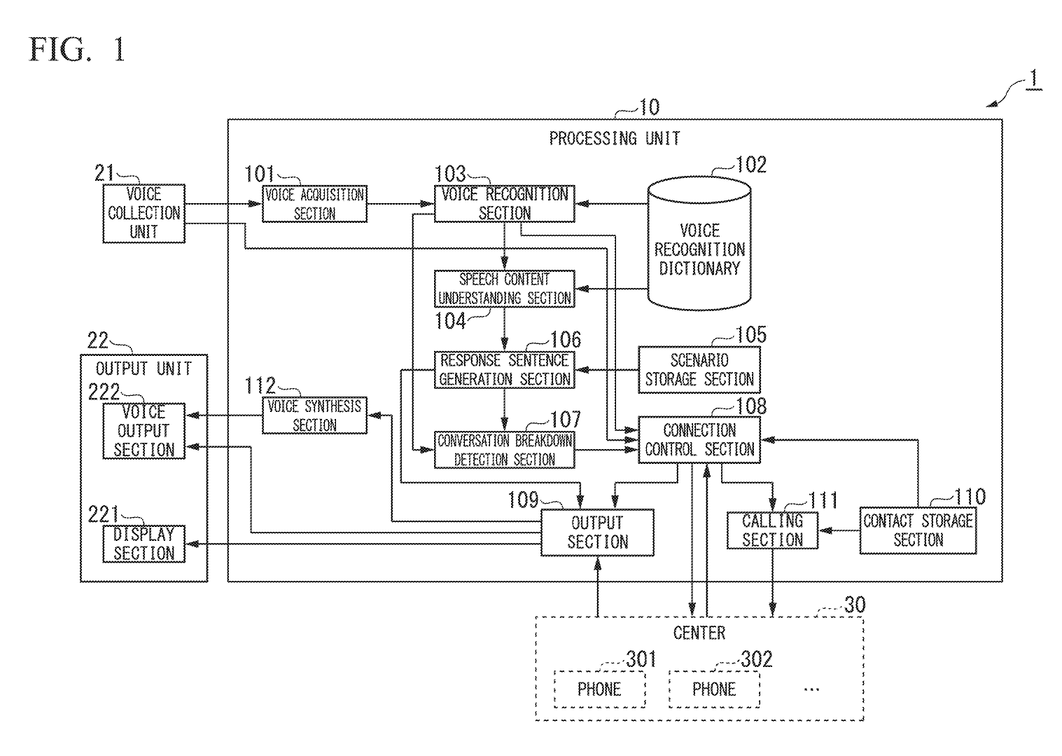

FIG. 1 is a diagram illustrating an example of a configuration of an interaction device 1 according to the present embodiment. As illustrated in FIG. 1, the interaction device 1 includes a processing unit 10, a voice collection unit 21, and an output unit 22. The processing unit 10 is connected to a center 30 via a wired line or a wireless communication line. Furthermore, an imaging unit may be connected to the processing unit 10. The center 30 includes a phone 301, a phone 302, . . . . In the following description, when one of the phone 301, the phone 302, . . . is not specified, they are called a phone 300. It should be noted that the center 30 includes at least one phone 300.

Furthermore, it is assumed that more than one of the interaction device 1, for example, is installed at the reception.

The processing unit 10 includes a voice acquisition section 101, a voice recognition dictionary 102, a voice recognition section 103, a speech content understanding section 104, a scenario storage section 105, a response sentence generation section 106, a conversation breakdown detection section 107 (a detection section), a connection control section 108, an output section 109, a contact storage section 110, a calling section 111, and a voice synthesis section 112.

The output unit 22 includes a display section 221 and a voice output section 222.

The voice collection unit 21 is a microphone. The voice collection unit 21 collects speech of a speaker and outputs the collected voice signal to the processing unit 10. The voice collection unit 21 outputs the collected voice signal to the connection control section 108 after a connection to the phone 300 of the center 30 is completed. It should be noted that the voice collection unit 21 may be a microphone array configured by two or more microphones. It should be noted that when the voice collection unit 21 is a microphone array, the interaction device 1 further includes a sound source localization unit, a sound source separation unit, and a sound source identification unit.

The output unit 22 displays character information output by the processing unit 10. Furthermore, the output unit 22 reproduces voice information output by the processing unit 10.

The display section 221, for example, is a liquid crystal display device, an organic electroluminescence display device, an electronic ink display device and the like. The display section 221 displays the character information output by the processing unit 10.

The voice output section 222 is a loudspeaker (speaker device). The voice output section 222 reproduces the voice information output by the voice synthesis section 112 of the processing unit 10. Alternatively, the voice output section 222 reproduces a voice signal output by the output section 109 of the processing unit 10.

The processing unit 10 understands a speech content of the voice signal output by the voice collection unit 21 and outputs a response for the speech of the speaker. When it is determined that the speech content of the speaker has been broken, the processing unit 10 connects to the phone 300 of the center on the basis of the speech content and an empty state (the state of use of a line) of the center.

The voice acquisition section 101 acquires the voice signal output by the voice collection unit 21 and outputs the acquired voice signal to the voice recognition section 103. It should be noted that when the acquired voice signal is an analog signal, the voice acquisition section 101 converts the analog signal to a digital signal and outputs the digital signal to the voice recognition section 103.

The voice recognition dictionary 102, for example, stores an acoustic model, a language model, a word dictionary and the like. The acoustic model is a model based on a feature amount of sound and the language model is a model of information on words and an arrangement method thereof. Furthermore, the word dictionary is a dictionary with many vocabularies and for example, is a large vocabulary word dictionary.

The voice recognition section 103 acquires the voice signal output by the voice acquisition section 101. The voice recognition section 103 detects a voice signal of a speech section from the voice signal output by the voice acquisition section 101. In the detection of the speech section, for example, a voice signal equal to or more than a predetermined threshold value is detected as a speech section. It should be noted that the voice recognition section 103 may detect the speech section by using other well-known methods. The voice recognition section 103 performs voice recognition with respect to the detected voice signal of the speech section by using well-known methods with reference to the voice recognition dictionary 102. It should be noted that the voice recognition section 103, for example, performs the voice recognition by using the method disclosed in Japanese Unexamined Patent Application Publication No. 2015-64554, and the like. The voice recognition section 103 outputs the recognized recognition result and the voice signal to the speech content understanding section 104 and the conversation breakdown detection section 107. Furthermore, the voice recognition section 103 outputs the voice signal to the connection control section 108. It should be noted that the voice recognition section 103 outputs the recognition result and the voice signal every one sentence or every speech section for example.

The speech content understanding section 104 converts the recognition result (the voice signal) output by the voice recognition section 103 into a text with reference to the voice recognition dictionary 102. The speech content understanding section 104 outputs the converted text information to the response sentence generation section 106. It should be noted that the speech content understanding section 104 may convert the recognition result (the voice signal) into a text inclusive of interjections such as “ah”, “uh”, “huh”, and “wow”.

The scenario storage section 105 stores a conversation, which is performed in an environment in which the interaction device 1 is used, in a text format for example. When the interaction device 1, for example, is used in the reception of a company, the conversation, for example, is a conversation with a speaker in calling a person in charge. When the interaction device 1, for example, is used in the reception of a hospital, the conversation, for example, is a conversation with a speaker in receiving a reservation. Such a scenario may be stored in the scenario storage section 105 in advance, may be rewritten or appended in accordance with use environments, or may be used to store results of learning based on a conversation with a speaker.

The response sentence generation section 106 acquires the text information and the recognition result (the voice signal) output by the speech content understanding section 104. The response sentence generation section 106 generates a response sentence for the acquired text information with reference to the scenario stored in the scenario storage section 105. The response sentence generation section 106 outputs the acquired text information of the speaker and the generated response sentence (text information) to the conversation breakdown detection section 107 in an order of the conversation.

The conversation breakdown detection section 107 determines whether the conversation between the speaker and the interaction device 1 has been broken by using the text information of the speaker and the generated response sentence (text information) output by the response sentence generation section 106. Alternatively, the conversation breakdown detection section 107 determines whether the conversation between the speaker and the interaction device 1 has been broken by using the voice signal output by the voice recognition section 103. A method for determining whether the conversation between the speaker and the interaction device 1 has been broken will be described later. When it is determined that the conversation has been broken, the conversation breakdown detection section 107 outputs information indicating that the conversation has been broken to the connection control section 108. When it is determined that the conversation has not been broken, the conversation breakdown detection section 107 outputs information indicating that the conversation has not been broken to the connection control section 108.

The connection control section 108 estimates a sincerity score on the basis of the voice signal output by the voice recognition section 103. A method for estimating the sincerity score will be described later. The connection control section 108, for example, acquires the state of use of a line of the phone 300 from the center 30 at a predetermined cycle, updates the acquired state of use of the line, and stores the updated state in the contact storage section 110. The connection control section 108 reads information indicating the state of use of the line stored in the contact storage section 110. The connection control section 108 obtains a congestion degree of the center on the basis of the state of use of the line. It should be noted that the state of use of the line of the center 30 indicates the state of use of the phone 300 and the state of use of the phone 300 indicates whether a person in charge using the phone 300 is in conversation. A method for obtaining the congestion degree will be described later. The connection control section 108 calculates a center connection score by using the estimated sincerity score and the obtained congestion degree. The connection control section 108 compares the calculated center connection score with a threshold value and determines whether to connect to the center or continue the conversation. When connecting to the center, the connection control section 108 outputs a call request to the calling section 111. It should be noted that the call request output to the calling section 111, for example, includes information indicating an extension number. Furthermore, when connecting to the center 30, the connection control section 108 generates a call response sentence (text information) indicating the connection to the center 30, and outputs the generated call response sentence (the text information) and the call request to the output section 109. When continuing the conversation, the connection control section 108 outputs a request for continuing the conversation to the output section 109. When the connection to the phone 300 of the center 30 is completed, the connection control section 108 outputs the voice signal output by the voice collection unit 21 to a connected phone 300.

The output section 109 outputs the response sentence (the text information) generated by the response sentence generation section 106 to the display section 221 when the request for continuing the conversation is received from the connection control section 108. It should be noted that when the request for continuing the conversation is received from the connection control section 108, the output section 109 may output the response sentence generated by the response sentence generation section 106 to the voice synthesis section 112.

The output section 109 outputs the response sentence (the text information) generated by the response sentence generation section 106 and the call response sentence (the text information) to the display section 221 when the call request is received from the connection control section 108. It should be noted that when the call request is received from the connection control section 108, the output section 109 may output the response sentence generated by the response sentence generation section 106 and the call response sentence to the voice synthesis section 112.

After the connection to the phone 300 of the center 30 is completed, the output section 109 acquires a voice signal output by the phone 301 and outputs the acquired voice signal to the voice output section 222.

The contact storage section 110 stores an extension number of, for example, the phone 300 of the center 30. Furthermore, the contact storage section 110 stores an extension number of a connected phone 300 of the center 30 or stores an extension number of an unconnected phone 300 of the center 30. The contact storage section 110 stores the state of use of the line.

The calling section 111 connects to a phone 300 with the extension number included in the call request output by the connection control section 108.

The voice synthesis section 112 converts voice information output by the output section 109 into a voice signal by, for example, a formant synthesis method and the like, and outputs the converted voice signal to the voice output section 222.

The phone 300 includes a handset (a microphone and a loudspeaker), a device for inputting a number, and the like. The phone 300, for example, is used by an operator. The phone 300 reproduces a voice signal output by the interaction device 1 after a connection to the interaction device 1 is completed, and outputs a voice signal uttered by an operator to the interaction device 1.

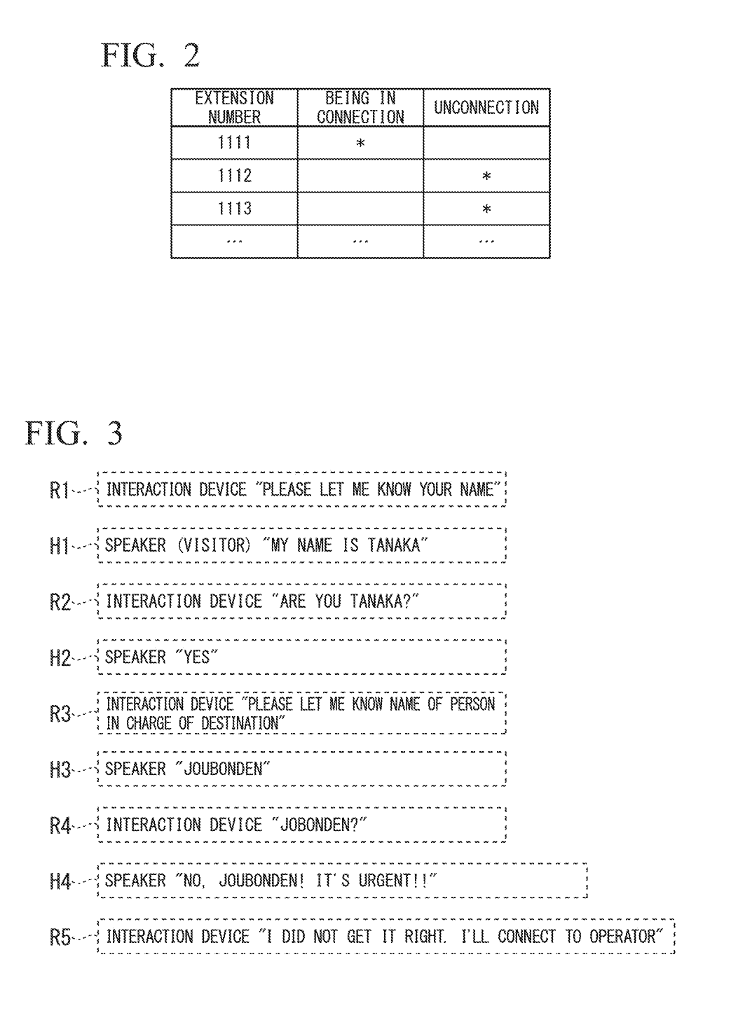

FIG. 2 is a diagram illustrating an example of information stored in the contact storage section 110 according to the present embodiment.

As illustrated in FIG. 2, the contact storage section 110 stores information indicating a connection to an extension number or a non-connection to an extension number in correlation with the extension number. In FIG. 2, the symbol * (asterisk) indicates a connected state or an unconnected state. In the example of FIG. 2, an extension number “1111” is in the connected state and extension numbers “1112” and “1113” are in the unconnected state.

Next, an example of a conversation between the interaction device 1 and a speaker (a visitor) will be described.

FIG. 3 is a diagram illustrating an example of a conversation between the interaction device 1 and a speaker (a visitor) according to the present embodiment. In FIG. 3, a reference numeral Rn (n is an integer equal to or more than 1) indicates the speech (a response sentence) of the interaction device and a reference numeral Hn indicates the speech of the speaker (the visitor). It should be noted that the example of FIG. 3 is an example in which the interaction device 1 is installed at the reception of a company. The interaction device 1 causes the display section 221 to display the response sentence or reproduces the response sentence from the voice output section 222.

As illustrated in FIG. 3, in order to check whether the understanding result of the speech content of the speaker is correct, the interaction device 1 repeats the understanding result as a response sentence after the speech of the speaker as indicated by the reference numerals R2 and R4. The interaction device 1 determines that the understanding is correct from the speech of the speaker after the reference numeral R2 and continues the conversation. Moreover, the interaction device 1 determines that the understanding is incorrect from the speech of the speaker after the reference numeral R4, detects that a pitch has changed from the speech of the speaker in the reference numeral R4, and extracts “urgency” as a keyword. In this example, since the sincerity score is high and the center is empty, the interaction device 1 connects to an operator. When calling the operator, the interaction device 1 adds “I will connect to an operator” to a response sentence.

It should be noted that the conversation illustrated in FIG. 3 is an example, and the present invention is not limited thereto.

Next, an example of a method for determining whether the conversation between the speaker and the interaction device 1 has been broken will be described.

The conversation breakdown detection section 107 determines whether the conversation between the speaker and the interaction device 1 has been broken by the method disclosed in the cited reference, for example, on the basis of whether the speaker has repeated the same speech. Furthermore, when it is detected that the speaker is in a silent state (not speech) for a predetermined time, the conversation breakdown detection section 107 determines that the conversation has been broken. Furthermore, when text information of the speaker includes a word (for example, “being in trouble” or “not like that”) indicating hesitation to speak or embarrassment for a response sentence, the conversation breakdown detection section 107 determines whether the conversation has been broken. Alternatively, on the basis of determination information, the conversation breakdown detection section 107 calculates a score regarding whether a manner of speaking of the speaker has changed, and determines that the conversation has been broken when it is possible to detect whether the score exceeds a threshold value. It should be noted that the determination information is at least one of a “change in the speed of the speech of the speaker”, a “change in the prosody (F0) of the speech of the speaker”, and a “change in the volume of the speech of the speaker”. The conversation breakdown detection section 107 detects the “change in the speed of the speech of the speaker” with respect to the recognition result (the voice signal) output by the voice recognition section 103, and obtains the score on the basis of the magnitude of the change. The conversation breakdown detection section 107 detects the “change in the prosody (F0) of the speech of the speaker” with respect to the recognition result (the voice signal) output by the voice recognition section 103, and obtains the score on the basis of the magnitude of the change. The conversation breakdown detection section 107 detects the “change in the volume of the speech of the speaker” with respect to the recognition result (the voice signal) output by the voice recognition section 103, and obtains the score on the basis of the magnitude of the change.

[Cited reference] “Detection and recognition of repetitive correction speech of user for erroneous recognition of voice interaction system”, Norihide Kitaoka, Naoko Kakutani, Seiichi Nakagawa, The Transactions of the Institute of Electronics, Information and Communication Engineers (D-II), Vol. J87-D-II No. 7, 1441-1450, July, 2004

Next, a method for obtaining the congestion degree of the center 30 will be described.

For example, it is assumed that 10 phones 300 are installed in the center 30. In such a case, when one of the phones 301, 302, . . . , 310 is connected, the connection control section 108 obtains 1 {=(1/10)×10} as the congestion degree. Furthermore, when nine phones are connected, the connection control section 108 obtains 9 {=(9/10)×10} as the congestion degree. It should be noted that the connection control section 108 may store the congestion degree in the contact storage section 110 in correlation with the state of use in the form of a table for example, and obtain the congestion degree with reference to the stored information.

Next, a method for calculating the center connection score will be described.

Hereinafter, it is assumed that the sincerity score is X and the congestion degree is Y. The connection control section 108 calculates the center connection score by a formula (γX+δY) for example. In the formula above, γ denotes a weighting factor of the sincerity score and δ denotes a weighting factor of the congestion degree. It should be noted that the weighting factors are values obtained by machine learning.

Next, an example of a procedure performed by the interaction device 1 will be described.

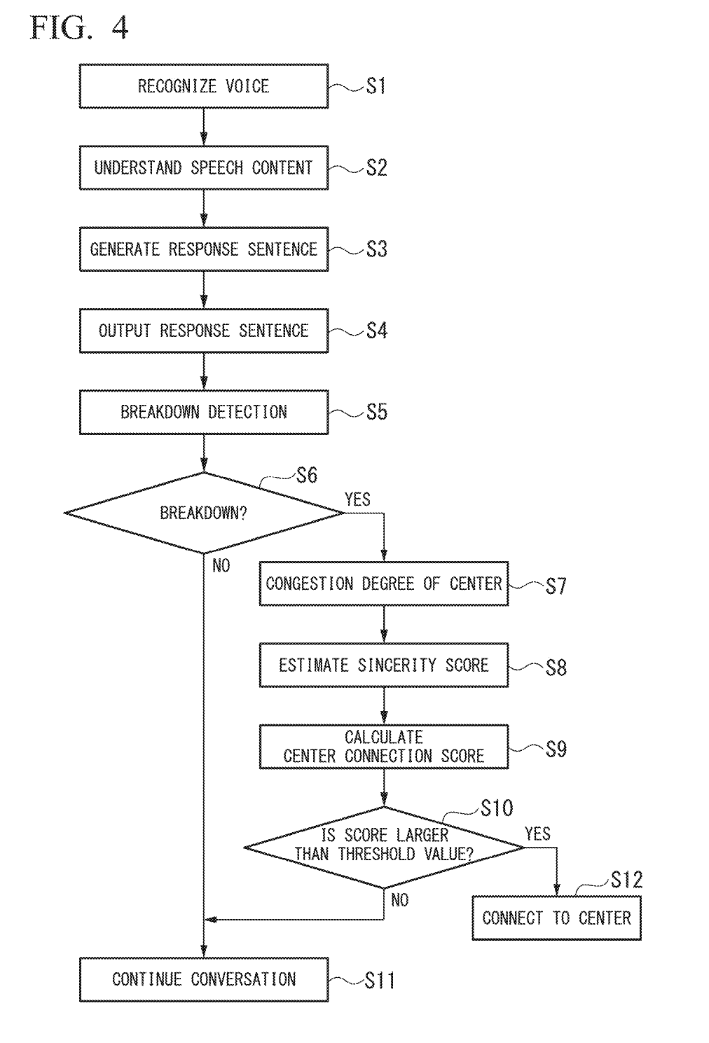

FIG. 4 is a flowchart illustrating an example of a procedure performed by the interaction device 1 according to the present embodiment.

(Step S1) The voice recognition section 103 performs a voice recognition process with respect to an acquired speech of a speaker by using the voice recognition dictionary 102.

(Step S2) The speech content understanding section 104 converts the speech of the speaker recognized by the voice recognition section 103 into text information by using the voice recognition dictionary 102 (also called a speech content understanding process).

(Step S3) The response sentence generation section 106 generates a response sentence for the text information on the basis of the scenario stored in the scenario storage section 105.

(Step S4) The output section 109 outputs the response sentence to the display section 221. Subsequently, the display section 221 displays the response sentence.

(Step S5) The conversation breakdown detection section 107 detects whether the conversation between the interaction device 1 and the speaker has been broken by the aforementioned method on the basis of the text information of the speaker and the response sentence output by the response sentence generation section 106. Furthermore, on the basis of the recognition result (the voice signal of the speaker) output by the voice recognition section 103, the conversation breakdown detection section 107 detects whether the conversation between the interaction device 1 and the speaker has been broken by the aforementioned method.

(Step S6) As the result of detecting whether the conversation between the interaction device 1 and the speaker has been broken, the conversation breakdown detection section 107 proceeds to a process of Step S7 when the conversation has been broken (Step S6; YES) and proceeds to a process of Step S11 when the conversation has not been broken (Step S6; NO).

(Step S7) The connection control section 108 acquires the state of use of the line of the center 30 and obtains the congestion degree of the center on the basis of the acquired state of use of the line.

(Step S8) The connection control section 108 receives information output by the conversation breakdown detection section 107 and indicating that the conversation has been broken. Subsequently, the connection control section 108 estimates the sincerity score by the aforementioned method by using a keyword output by the speech content understanding section 104, the text information on the speech of the speaker output by the conversation breakdown detection section 107, and the voice signal of the speaker.

(Step S9) The connection control section 108 calculates the center connection score by using the estimated sincerity score and the obtained congestion degree as described above.

(Step S10) The connection control section 108 determines whether the calculated center connection score is larger than a threshold value. When it is determined that the center connection score is larger than the threshold value (Step S10; YES), the connection control section 108 proceeds to a process of Step S12, and when it is determined that the center connection score is smaller than the threshold value (Step S10; NO), the connection control section 108 proceeds to the process of Step S11.

(Step S11) The connection control section 108 repeats Steps S1 to S10 and continues the conversation. Therefore, the connection control section 108 does not output a call request to the calling section 111. That is, the interaction device 1 does not connect to a phone 300 of the center 30.

(Step S12) The connection control section 108 outputs the call request to the calling section 111. Subsequently, the calling section 111 connects to the center by connecting to a phone 300 with an extension number included in the call request.

It should be noted that the aforementioned example has described an example in which the sincerity score is estimated after the congestion degree is obtained; however, the present invention is not limited thereto. The connection control section 108 may obtain the congestion degree after the sincerity score is estimated, or may perform the estimation process of the sincerity score and the obtaining process of the congestion degree in a parallel manner.

Furthermore, the threshold value in Step S10 is set in advance by a user of the interaction device 1 in accordance with the number of phones 300 included in the center 30, the congestion degree, and the sincerity score. It should be noted that the threshold value may be changed by the interaction device 1 in accordance with a change in the number of phones 300 available according to the working hours of the center 30, the experience level of an operator, and the like.

As described above, in the present embodiment, when a phone 300 included in the center 30 is in an empty state, that is, when a person in charge of the center 30 is in a vacant state, a connection between a speaker and the person in charge of the center 30 is controlled.

In this way, according to the present embodiment, it is possible to perform communication between a speaker required to communicate with a person in charge and the person in charge in accordance with an empty state of a phone 300 of the center 30, that is, a vacant state of the person in charge.

Furthermore, in the related art, in a case where the interaction device 1 is disposed at many bases and is used by many visitors at the same time, there is a possibility that it is not possible to cope with a situation where every interaction device 1 in which a conversation has been broken connects all speakers to the center 30, due to a lack of human resources.

On the other hand, according to the present embodiment, a speaker required to communicate with a person in charge and the person in charge are connected to each other in accordance with a vacant state of the person in charge, so that it is possible to reduce lack of human resources.

### Modification Example

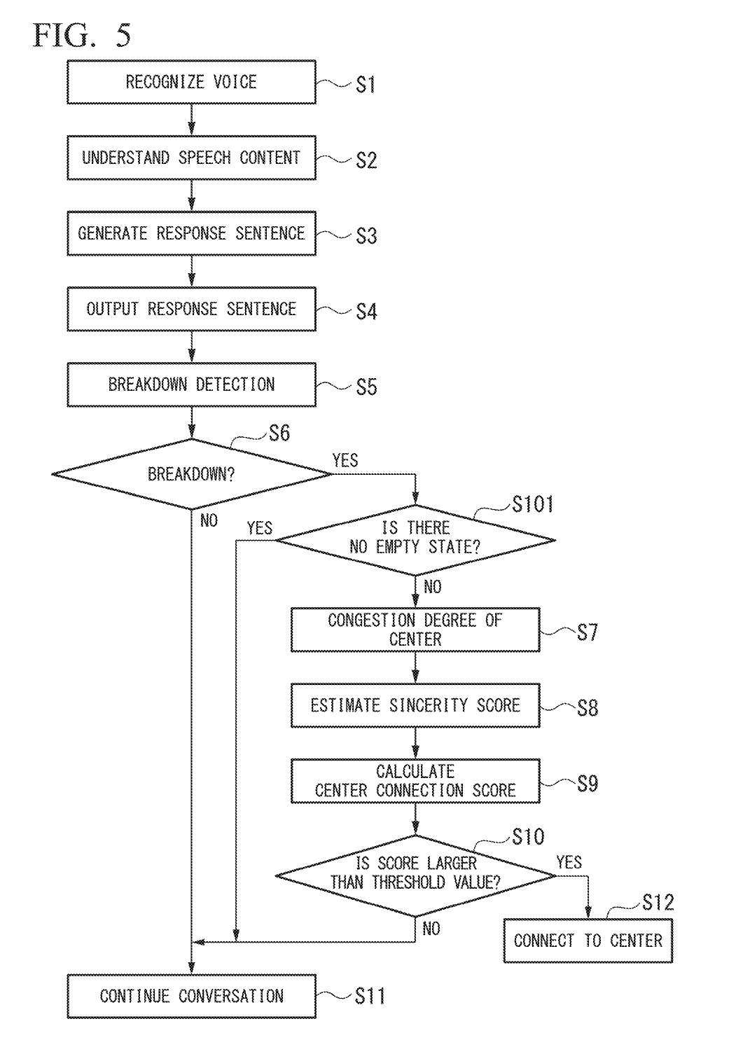

The embodiment has described an example in which connection or non-connection to the center is determined after the center connection score is calculated; however, the present invention is not limited thereto. Firstly, the state of use of the line of the center 30 may be checked. FIG. 5 is a flowchart illustrating an example of a procedure performed by an interaction device 1 in a modification example of the present embodiment. It should be noted that the configuration of the interaction device 1 is identical to that of FIG. 1. Furthermore, processes identical to those of FIG. 4 are denoted by the same reference numerals and a description thereof will be omitted.

(Steps S1 to S6) The interaction device 1 performs the processes of Steps S1 to S6. Then, the interaction device 1 proceeds to a process of Step S101.

(Step S101) The connection control section 108 acquires the state of use of the line of the center 30. Subsequently, the connection control section 108 checks whether there is an unconnected phone 300 in the center 30. When it is determined that there is no unconnected phone 300, that is, when it is determined that there is no empty state (Step S101; YES), the connection control section 108 proceeds to the process of Step S11 because it is not possible to connect to the center 30. When it is determined that there is an unconnected phone 300, that is, when it is determined that there is an empty state (Step S101; NO), the connection control section 108 proceeds to the process of Step S7 because it is possible to connect to the center 30.

(Steps S7 to S12) The interaction device 1 performs the processes of Steps S7 to S12.

As described above, according to the modification example, when a person in charge of the center 30 is vacant and a conversation has been broken, it is possible to connect to the person in charge of the center 30, and when the person in charge of the center 30 is not vacant, it is possible to continue a conversation with a speaker.

### Second Embodiment

The first embodiment has described an example in which the sincerity score is estimated on the basis of at least one of a change in the prosody of the speech of the speaker, a change in the speed of the speech of the speaker, and a change in the volume of the speech of the speaker; however, the present invention is not limited thereto. The estimation of the sincerity score may be based on the speech content of the speaker.

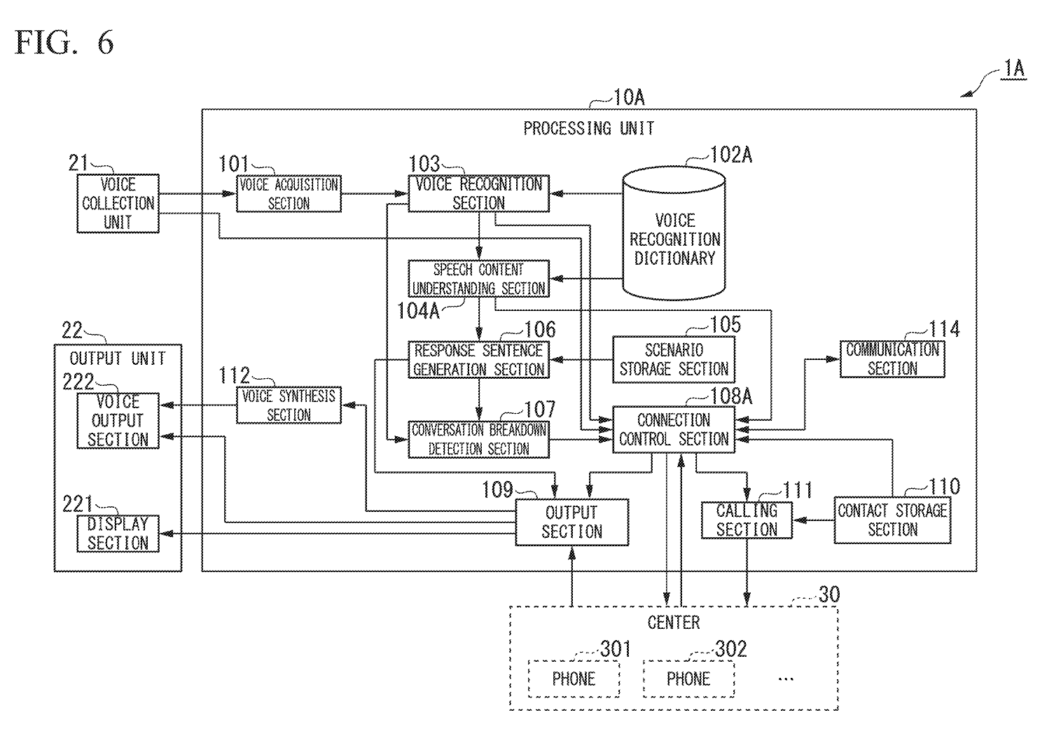

FIG. 6 is a diagram illustrating an example of a configuration of an interaction device 1A according to the present embodiment. As illustrated in FIG. 6, the interaction device 1A includes a processing unit 10A, a voice collection unit 21, and an output unit 22. It should be noted that functional parts having the same functions as those of the interaction device 1 of the first embodiment are denoted by the same reference numerals and a description thereof will be omitted.

The processing unit 10A includes a voice acquisition section 101, a voice recognition dictionary 102A, a voice recognition section 103, a speech content understanding section 104A, a scenario storage section 105, a response sentence generation section 106, a conversation breakdown detection section 107 (a detection section), a connection control section 108A, an output section 109, a contact storage section 110, a calling section 111, a voice synthesis section 112, and a communication section 114.

The communication section 114 acquires information from another interaction device 1A and outputs the acquired information to the connection control section 108A. Furthermore, the communication section 114 outputs information output by the connection control section 108A to the other interaction device 1A. It should be noted that the interaction device 1A and the other interaction device 1A are connected to each other a wired or wireless network.

The voice recognition dictionary 102A further stores a keyword. The keyword is a term with high urgency. The term with high urgency differs in an environment in which the interaction device 1A is used. For example, when the interaction device 1A is used in a public place, the term with high urgency, for example, includes “please help me”, “please call the police”, “please take me to the hospital” and the like. Furthermore, the voice recognition dictionary 102A stores the keyword in correlation with a priority.

It should be noted that the keyword and the priority are changed in accordance with an environment in which the interaction device 1A is installed.

The speech content understanding section 104A further refers to the voice recognition dictionary 102A and determines whether the keyword is included in a recognition result. When the keyword is included, the speech content understanding section 104A outputs information indicating that the keyword is included, the keyword, and information indicating a priority of the keyword to the connection control section 108A.

The connection control section 108A estimates the sincerity score on the basis of the information indicating that the keyword is included, the keyword, and the information indicating the priority of the keyword output by the speech content understanding section 104A. It should be noted that the connection control section 108A may estimate the sincerity score on the basis of at least one of a “change in the speed of the speech of the speaker”, a “change in the prosody of the speech of the speaker”, a “change in the volume of the speech of the speaker”, and the priority of the keyword. Furthermore, the connection control section 108A may estimate the sincerity score on the basis of at least one of the keyword, the “change in the speed of the speech of the speaker”, the “change in the prosody of the speech of the speaker”, and the “change in the volume of the speech of the speaker”. It should be noted that an estimation formula of the sincerity score is obtained from data through machine learning.

The connection control section 108A obtains the congestion degree of the center. The connection control section 108A calculates the center connection score on the basis of the aforementioned congestion degree and the estimated sincerity score. The connection control section 108A compares the calculated center connection score with a threshold value and determines whether to connect to the center 30 or continue a conversation.

It should be noted that when a plurality of interaction devices 1A are used at the same time, the interaction devices 1A set one of the plurality of interaction devices 1A as a master in advance. It should be noted that the master may be set by a system administrator of the interaction devices 1A.

Then, before connecting to the center 30, the connection control section 108A outputs the priority of the keyword estimated in the interaction device 1A to another interaction device 1A via the communication section 114. Then, the connection control section 108A acquires a priority of the keyword output by the other interaction device 1A via the communication section 114. The connection control section 108A compares the priority of the interaction device 1A with the priority of the other interaction device 1A, decides an order of a connection to the center 30 on the basis of the comparison result, and outputs the decided order to the other interaction device 1A. Each interaction device 1A connects to the center 30 on the basis of the acquired connection order.

As described above, in the present embodiment, the sincerity score is estimated on the basis of the priority of the keyword included in the speech of a speaker.

In the way, according the present embodiment, when a plurality of interaction devices 1A are installed and a plurality of speakers respectively use the plurality of interaction devices 1A, speakers with higher priority conversations can be sequentially connected to an operator.

### Third Embodiment

The first embodiment and second embodiment have described examples in which the sincerity score is estimated on the basis of the voice signal uttered by a speaker; however, an image may be used in estimating the sincerity score.

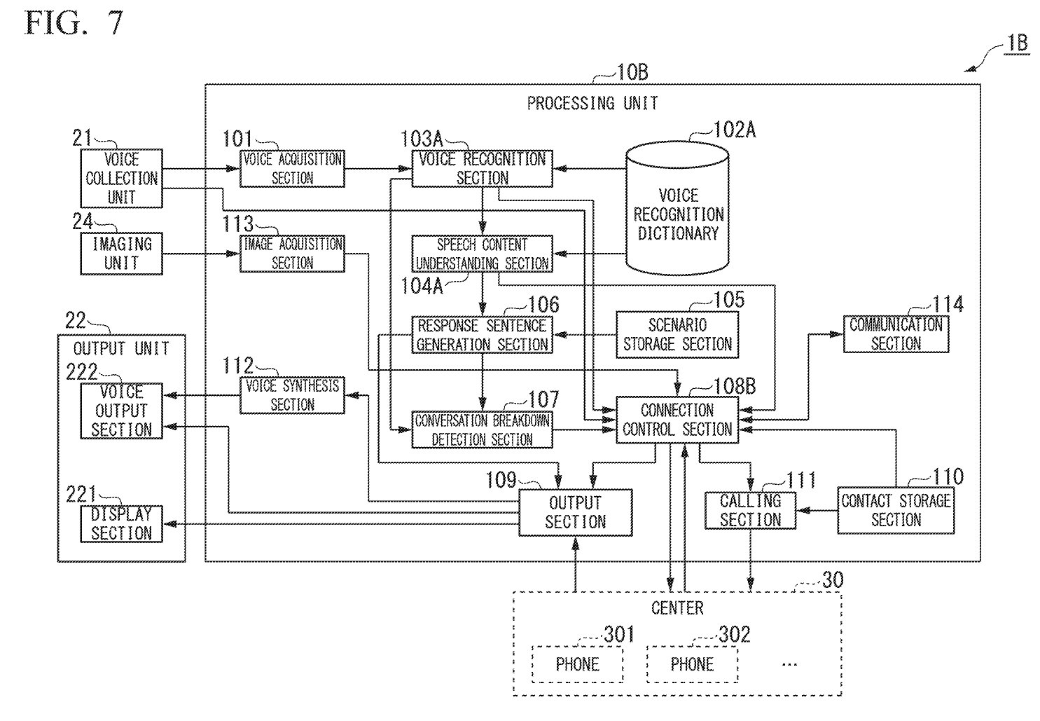

FIG. 7 is a diagram illustrating an example of a configuration of an interaction device 1B according to the present embodiment. As illustrated in FIG. 7, the interaction device 1B includes a processing unit 10B, a voice collection unit 21, and an output unit 22. An imaging unit 24 is connected to the processing unit 10B. It should be noted that the configuration illustrated in FIG. 7 is an example applied to the interaction device 1A described in the second embodiment, but can also be applied to the interaction device 1 described in the first embodiment. Furthermore, functional parts having the same functions as those of the interaction device 1 or the interaction device 1A are denoted by the same reference numerals and a description thereof will be omitted.

The processing unit 10B includes a voice acquisition section 101, a voice recognition dictionary 102A, a voice recognition section 103A, a speech content understanding section 104A, a scenario storage section 105, a response sentence generation section 106, a conversation breakdown detection section 107 (a detection section), a connection control section 108B, an output section 109, a contact storage section 110, a calling section 111, a voice synthesis section 112, and an image acquisition section 113.

The imaging unit 24, for example, is a complementary MOS (CMOS) image sensor camera or a colony collapse disorder (CCD) image sensor camera. The imaging unit 24 outputs a captured image to the image acquisition section 113. The image may be a still image captured in a predetermined cycle or a moving image.

The image acquisition section 113 acquires the image output by the imaging unit 24 and outputs the acquired image to the connection control section 108B.

The connection control section 108B acquires the image output by the image acquisition section 113 and estimates the sincerity score on the basis of the acquired image. The connection control section 108B obtains the congestion degree of the center. The connection control section 108B compares a calculated center connection score with a threshold value and determines whether to connect to the center or continue a conversation.

Hereinafter, an example of an estimation method of the sincerity score by using an image will be described.

The connection control section 108B estimates the sincerity score by using an acquired image on the basis of the magnitude of a change in the attitude and the line of sight of a speaker who is talking. Furthermore, the connection control section 108B estimates the sincerity score by using the acquired image on the basis of the magnitude of a change in the attitude and the line of sight of the speaker until the interaction device 1B responds after the speech. Alternatively, the connection control section 108B estimates the sincerity score by using the acquired image on the basis of the magnitude of a change in the attitude and the line of sight of the speaker during the response of the interaction device 1B after the speech. It should be noted that the connection control section 108B detects the “change in the attitude and the line of sight of the speaker who is talking”, the “change in the attitude and the line of sight of the speaker until the interaction device 1B responds after the speech”, and the “change in the attitude and the line of sight of the speaker during the response of the interaction device 1B after the speech” by well-known image recognition methods. Furthermore, an estimation formula of the score is obtained from data through machine learning.

It should be noted that before connecting to the center 30, the connection control section 108B outputs the sincerity score estimated in the interaction device 1B to another interaction device 1B via the communication section 114. Then, the connection control section 108B acquires a sincerity score output by the other interaction device 1B via the communication section 114. The connection control section 108B compares the sincerity score of the interaction device 1B with the sincerity score of the other interaction device 1B, decides an order of a connection to the center 30 on the basis of the comparison result, and outputs the decided order to the other interaction device 1B. Each interaction device 1B connects to the center 30 on the basis of the acquired connection order.

It should be noted that the connection control section 108B may estimate the sincerity score on the basis of at least one of the aforementioned “change in the speed of the speech of the speaker”, “change in the prosody of the speech of the speaker”, “change in the volume of the speech of the speaker”, and the priority of the keyword, in addition to the estimation of the sincerity score based on an image.

As described above, in the present embodiment, the sincerity score of the speech of a talking speaker is estimated using an image obtained by capturing the talking speaker.

In the way, according the present embodiment, the image obtained by capturing the speaker is used, so that it is possible to estimate the sincerity score more accurately.

<Sincerity Score>

Hereinafter, the estimation methods of the sincerity score used in the aforementioned first to third embodiments will be further described. The connection control section 108 (or 108A, 108B) estimates the sincerity score by at least one of the following information.

(i) Keyword included in a speaker's speech and indicating urgency; A

(ii) Change in prosody (F0) of speaker's speech; B

(iii) Change in speed of speaker's speech; C

(iv) Change in volume of speaker's speech; D

(v) Change in attitude and line of sight of talking speaker; E

(vi) Change in attitude and line of sight of speaker until interaction device 1 responds after speech; F, and

(vii) Change in attitude and line of sight of speaker during response of interaction device 1 after speech; G

It should be noted that the connection control section 108 (or 108A, 108B) obtains the score estimation formulas of (i) to (vii) from data through machine learning. These estimation formulas are learned in advance and are stored in the connection control section 108 (or 108A, 108B). Furthermore, when the information of (v) to (vii) is used, the connection control section 108 (or 108A, 108B) detects the above changes by using image information acquired by the image acquisition section 113, and obtains the sincerity score on the basis of the magnitudes of the changes.

The connection control section 108 (or 108A, 108B) may estimate the sincerity score by using a plurality of types of information of the aforementioned information. For example, when (ii) and (iv) is used, the connection control section 108 (or 108A, 108B) may estimate the sincerity score through αB+βD by using weighting factors. In the above, α denotes a weighting factor of B and β denotes a weighting factor of D. It should be noted that the weighting factors are values obtained by machine learning.

It should be noted that the aforementioned interaction device 1 (or 1A, 1B), for example, may also be applied to a bipedal humanoid robot, a humanoid robot with only an upper body, a tablet terminal, a smartphone and the like.

It should be noted that a program for realizing all or some of the functions of the processing unit 10 (or 10A, 10B) in the present invention is recorded on a computer readable recording medium and a computer system is allowed to read and execute the program recorded on the recording medium, so that all or some of the processes performed by the processing unit 10 (or 10A, 10B) may be performed. It should be noted that the “computer system” herein is assumed to include an OS and hardware such as a peripheral device. Furthermore, the “computer system” is assumed to include a WWW system with a homepage providing environment (or a display environment). Furthermore, the “computer readable recording medium” indicates a portable medium such as a flexible disk, a magneto-optical disc, a ROM, and a CD-ROM, and a storage unit such as a hard disk embedded in the computer system. Moreover, the “computer readable recording medium” is assumed to include a medium for holding the program for a constant time period such as a volatile memory (RAM) in the computer system serving as a server or a client in the case in which the program has been transmitted via a network such as the Internet or a communication line such as a telephone line.

Furthermore, the aforementioned program may be transmitted from a computer system having stored the program in a storage device and the like to other computer systems via a transmission medium or a transmission wave of the transmission medium. In this case, the “transmission medium” for transmitting the program indicates a medium having an information transmission function such as a network (a communication network) such as the Internet and a communication line such as a telephone line. Furthermore, the aforementioned program may be a program for realizing some of the aforementioned functions. Moreover, the aforementioned program may also be a program capable of realizing the aforementioned functions by a combination with a program previously recorded in the computer system, a so-called difference file (a difference program).

While preferred embodiments of the invention have been described and illustrated above, it should be understood that these are exemplary of the invention and are not to be considered as limiting. Additions, omissions, substitutions, and other modifications can be made without departing from the spirit or scope of the present invention.

What is claimed is:

1. An interaction device comprising:
a voice collection unit configured to collect a speech of a speaker;
a voice recognition section configured to recognize voice of the speech collected by the voice collection unit;
a speech content understanding section configured to understand a speech content on the basis of the recognized content;
a response sentence generation section configured to generate a response sentence in accordance with the speech content;
an output unit configured to output the response sentence;
a detection section configured to detect that the speech between the speaker and the interaction device has been broken; and
a connection control section configured to control a connection between the speaker and a person in charge of a center on the basis of the speech content understood by the speech content understanding section and a vacant state of the person in charge of the center when the speech has been broken.

2. The interaction device according to claim 1, wherein the connection control section determines whether a conversation with the person in charge of the center is required in the speech on the basis of at least one of a change in prosody of the speech of the speaker collected by the voice collection unit, a change in a speed of the speech of the speaker, and a change in volume of the speech of the speaker, and performs a connection to the person in charge of the center on the basis of a determined result.

3. The interaction device according to claim 1, wherein the connection control section determines a priority in accordance with the speech content and sets an order of a connection to the center on the basis of the priority.

4. The interaction device according to claim 3, wherein the priority corresponding to the speech content is changed in accordance with an environment in which the interaction device is used.

5. The interaction device according to claim 1, further comprising:
an imaging unit configured to capture an image,
wherein the connection control section determines a priority on the basis of the image captured by the imaging unit, and sets an order of a connection to the center on the basis of the priority.

6. A program causing a computer of an interaction device to perform:
a voice collection step of collecting a speech of a speaker;
a voice recognition step of recognizing voice of the speech collected in the voice collection step;
a speech content understanding step of understanding a speech content on the basis of the recognized content;
a response sentence generation step of generating a response sentence in accordance with the speech content;
an output step of outputting the response sentence;
a detection step of detecting that the speech between the speaker and the interaction device has been broken; and
a connection control step of controlling a connection between the speaker and a person in charge of a center on the basis of the speech content understood in the speech content understanding step and a vacant state of the person in charge of the center when the speech has been broken.
